(19) United States
(12) Patent Application Publication
(10) Pub. No.: US 2022/0408996 A1
(43) Pub. Date: Dec. 29, 2022

(54) VACUUM CLEANER WITH PROJECTED DISPLAY

(71) Applicant: Dyson Technology Limited, Wiltshire (GB)

(72) Inventors: Kristian Richard Thomas KING, Bristol (GB); Nathan LAWSON MCLEAN, Bristol (GB)

(73) Assignee: Dyson Technology Limited, Wiltshire (GB)

(21) Appl. No.: 17/777,990

(22) PCT Filed: Oct. 14, 2020
(86) PCT No.: PCT/GB2020/052573

§ 371 Date: May 18, 2022

(30) Foreign Application Priority Data
Nov. 20, 2019 (GB) 1916888.9

(51) Int. Cl. A47L 9/28

(52) U.S. Cl. CPC A47L 9/2857

(57) ABSTRACT

A vacuum cleaner is provided for cleaning a surface. The vacuum cleaner includes a main body, a tool, a projection surface, and a projector. The tool has a connector end for connection to the main body and a cleaner end opposite the connector end. The projection surface is provided on the tool, for displaying projected information thereon. The projector is configured for casting a projection including the projected information onto the projection surface.

### TECHNICAL FIELD

The present invention relates to a vacuum cleaner for cleaning a surface, such as a floor surface or a table top surface. The vacuum cleaner comprises a tool with a connector end and a cleaner end. A cleaner head may be provided at the cleaner end of the tool.

### BACKGROUND

Modern vacuum cleaners may comprise a display screen for displaying operational information, such as dust bin filling levels, a currently active mode of operation or how long the vacuum cleaner can be used before a filter may need to be cleaned or replaced. Cordless vacuum cleaners may provide information about battery charging levels and the expected amount of time the vacuum cleaner can be used before charging will be necessary. When adding touch screen technology, control functions can be added to such displays.

In EP 2 700 345 A1, a vacuum cleaner is disclosed using a projection unit for displaying information on a floor surface during use or on top of the main body of the vacuum cleaner when in a parking position. The floor projections disclosed in EP 2 700 345 A1 do, however, come with some disadvantages. Some projections are far away from where users would normally focus their attention, the colour and texture of the floor may render projections unreadable and in some situations, e.g. near walls or furniture, the projection may not even appear on the floor. In a disc shaped robotic vacuum cleaner disclosed in the same patent application, the projection is provided on the vacuum cleaner's top surface. In a further embodiment, a projection surface is mounted to a handle at the connector end of a vacuum cleaner wand. However, when vacuum cleaning a floor surface, the users' focus and attention is typically directed at the area being cleaned, not at the hand with which they hold the wand. Important information displayed on the handle-mounted projection surface may therefore be missed when paying attention to where the cleaner head is going. Furniture may be hit by the cleaner head when the user tries to read the display while moving.

EP 3 269 284 A1 discloses a projection system that is included in the cleaner head. The information to be displayed is projected onto the floor surface just in front of the cleaner head. This system has the disadvantage that it is situated far away from the main functional and electronic parts of the vacuum cleaner, while requiring a connection thereto. The projection system only works when the vacuum cleaner is used in combination with the specific cleaner head, making it impossible or very expensive to use it with different types of cleaner heads. Further, the readability of the projected information heavily depends on the colour and texture of the surface it is projected onto. When vacuuming nearby a wall or furniture, the information may not be readable at all.

It is an aim of the present invention to address one or more disadvantages associated with the prior art.

### SUMMARY OF THE INVENTION

According to an aspect of the invention there is provided a vacuum cleaner for cleaning a surface, the vacuum cleaner comprising a main body, a tool with a connector end for connection to the main body and a cleaner end opposite the connector end. A projection surface is provided on the tool for displaying projected information thereon. A projector is provided for casting a projection comprising the projected information onto the projection surface.

The vacuum cleaner may, e.g., be a handheld vacuum cleaner with a cleaner head being attached directly to the main body, or a stick type vacuum cleaner with an elongated wand. Where stick type vacuum cleaners are typically very useful for cleaning floor surfaces, handheld vacuum cleaners are more practical for above-floor surfaces, such as table tops, sofas, windowsills, etc. Providing the projection surface on the tool enables the user to read information from the display without losing focus on the surface area that is being cleaned.

Useful information about the device is displayed in the area where the user is already looking. This advantage is achieved without needing to project the information directly onto the surface itself and therefore improves its readability. Because of the use of projection for showing the information on the display surface, there is no need for providing complex and expensive electronic and optical equipment in, e.g., the cleaner head. The projector may be provided on or very close to the main body where all the other electronics and the power supply will generally be located. Further, because of the use of projection technology, there is no need to add any electrical wiring or use any wireless communication technology for transferring the information to be displayed from the connection end of the tool to the cleaner end. This is particularly important for stick vacuum cleaners.

The projection surface may, e.g., be mounted to the wand, at a position close to where the cleaner head is attached. Alternatively or additionally, when the cleaner head is connected to the cleaner end of the tool by a hinge, the projection surface may be mounted to a portion of the hinge that is fixedly mounted to the tool. Such hinge connections will typically be used in stick type vacuum cleaners to allow the user to vary his (or her) distance to the cleaner head while the cleaner head moves over the floor surface. However, also handheld vacuum cleaners may include a hinge in the cleaner head connection for allowing the user to vary the angle between the main body and the cleaner head. An important advantage of having the projection surface attached to the tool or the tool mounted portion of the hinge is that it may not have to be replaced when replacing the cleaner head and can be compatible with the use of different types of cleaner heads, such as e.g. a crevice tool. Furthermore, when the cleaner head hinges relative to the tool, the projection surface maintains its orientation relative to the user, thereby avoiding displacement or deformation of the projection.

Alternatively, the projection surface is provided on a top surface of the cleaner head. The top surface is herein defined as the surface opposite the surface contacting the surface during cleaning. In use, the top surface is generally parallel to the surface being cleaned, but it may be curved or inclined relative thereto. Projecting directly onto the top surface of the cleaner head obviates the use of a separate projection screen that adds weight and may get damaged when bumping into objects during use of the vacuum cleaner. Optionally, the cleaner head is connected to the cleaner end of the tool by a hinge, and the projector is configured for adjusting the projection in dependence of an angular position of the hinge. When pivoting the cleaner head relative to the projector, the angle of incidence of the projection onto the projection surface is altered. Often, such hinges are of the ball joint type, allowing the wand to be pivoted left and right, forward and backward and combinations thereof. The effect of such movements on the projection can be compensated by adjusting the projection itself, by mechanically adjusting the orientation of the projector relative to the tool or by a combination of both.

In an embodiment, the tool comprises a wand and the vacuum cleaner further comprises a second projection surface, the vacuum cleaner being configured for being used in a stick mode with the connector end of the wand attached to the main body and in a handheld mode with the wand removed from the main body. The second projection surface is provided at the main body or at the connector end of the wand. In a stick mode, i.e. with the wand attached to the main body, the information can be projected as described above, allowing the user to read the projected information while closely watching the cleaner head and the floor surface in its direct vicinity. With the wand removed, e.g. in order to use it in a handheld mode for cleaning furniture, windowsills and the like, the first projection surface is removed together with the wand. In that situation, the user can read the same information on the second projection surface that is part of the main body instead of on the first projection surface. In a preferred embodiment, the second projection surface may spring into position once the wand has been removed.

When used in stick mode, both projections may be visible simultaneously. Optionally, the projector is configured for adjusting the projection in dependence of a switch between the handheld mode and the stick mode. The switch may be realised automatically, e.g., when detecting that the wand is detached from the main body. The projected information may, e.g., be tailored to the specific use that is expected in the respective modes or it may be organised differently, redirected and/or rescaled to better suit the dimensions and position of the respective projection surface.

Optionally, the projector is arranged to be coupled to an optical fibre in such a way that, in the handheld mode, the projection is cast onto the second projection surface via the optical fibre. After the wand is detached from the main body in order to use the vacuum cleaner in handheld mode, the user can couple one end of the optical fibre to the projector. The other end of the optical fibre may already be connected to the main body in such a way that the projection is now shown on the second projection surface. Alternatively, the user will have to correctly connect the other end too. When switching from handheld mode to stick mode, the optical fibre is disconnected from the projector to allow the projector to project information onto the first projection surface again.

Alternatively, the projection surface may be configurable to be selectively provided at the cleaner end of the tool or at the connector end of the tool. While this may have some benefit in a handheld only vacuum cleaner, it is especially useful in a vacuum cleaner that can be operated in a stick mode and in a handheld mode. When switching between stick mode and hand held mode, the user can then relocate the projection surface. The projection may be adapted to suit the changed distance between the projector and the projection surface. If needed, also the direction of the projection will be adapted.

Optionally, the projection surface is mounted to the wand via a slidable mount that is freely movable between the cleaner end and the connector end of the wand. This allows the user to change the projection surface position without having to detach and attach it. Additionally, it allows the user to place the projection surface at a location somewhere in between its connector end and cleaner end positions, in accordance with their personal preferences. This may, e.g., be helpful for people with poor eyesight who may have problems with reading the information when the projection surface is located too close to the floor surface. When such a slidable mount is used, the projector may be configured to adjust the projection in dependence of a position of the slidable mount relative to the wand.

In another embodiment, the projection surface is configurable to be selectively provided at the cleaner end of the wand or at the connector end of the wand, and the projector is mounted to a slidable mount. With the projector mounted to a slidable mount, it will be advantageous to provide for wireless, e.g. WiFi™ or Bluetooth®, communication between the projector and a controller of the vacuum cleaner that generates and provides the necessary data and instructions for enabling the projection.

The projection surface may be mounted to the slidable mount too, which will bring the advantage that it can keep a constant distance to the projector and that the projection does not need to be adapted when the position of the slidable mount is changed.

The projector may be adaptably mounted to the slidable mount such that the projection can be selectively casted in either the direction of the cleaner end or in the direction of the connector end of the wand. When at the cleaner end, it can project the information onto a projection surface provided at the cleaner head side of the projector. When at the connector end, it can be rotated over about 180° to project the information onto a projection surface provided at the connector end of the wand or on a main body of the vacuum cleaner. The projector software may automatically flip the projection accordingly, such that the projected information always has the right orientation for the user.

The projection surface of any vacuum cleaner described above may be made of an at least partially transparent material, which allows the user to simultaneously see the projected information as well as the floor surface behind the projection surface. The projection may be such that it appears to the user that the information is projected onto the floor. Additionally, the projector is configured for adjusting a background colour of the projection and/or a colour of the projected information in dependence of a colour and/or texture of the floor surface. This will help to further improve the readability of the information.

According to a further aspect of the invention, a detachable element is provided, the detachable element being configured for attachment to a tool of a vacuum cleaner for cleaning a surface. The detachable element comprises a projection surface for displaying projected information thereon, and a projector for casting a projection comprising the projected information onto the projection surface. Such a detachable element may be used for providing the projector and the projection surface of one of the vacuum cleaners as described above.

Optionally, the detachable element is a slidable mount that is configured to be freely movable over at least a portion of the tool. The detachable element may comprise a first detachable element part and a separate or separable second detachable element part, the first detachable element part comprising the projection surface and the second detachable element part comprising the projector. When the detachable element consists of two separate parts, they can easily be attached in whatever relative orientation that is most suitable for the vacuum cleaner and its intended mode of use.

### BRIEF DESCRIPTION OF THE DRAWINGS

Embodiments of the invention will now be described by way of example with reference to the accompanying drawings, in which:

FIG. 1 schematically shows a vacuum cleaner with a projection surface on the cleaner head.

FIG. 2 schematically shows a vacuum cleaner with a projection screen mounted near the cleaner end of the wand.

FIGS. 3 and 4 show a vacuum cleaner with a projection system that can be used in different configurations.

FIGS. 5a and 5b show a vacuum cleaner with an adjustable projection screen.

FIGS. 6a and 6b show a vacuum cleaner with an adjustable projector.

FIGS. 7a and 7b show a further example of a projection system that can be used in different configurations.

FIGS. 8a and 8b show an example of a projection system that can be used with different types of vacuum cleaners.

### DETAILED DESCRIPTION

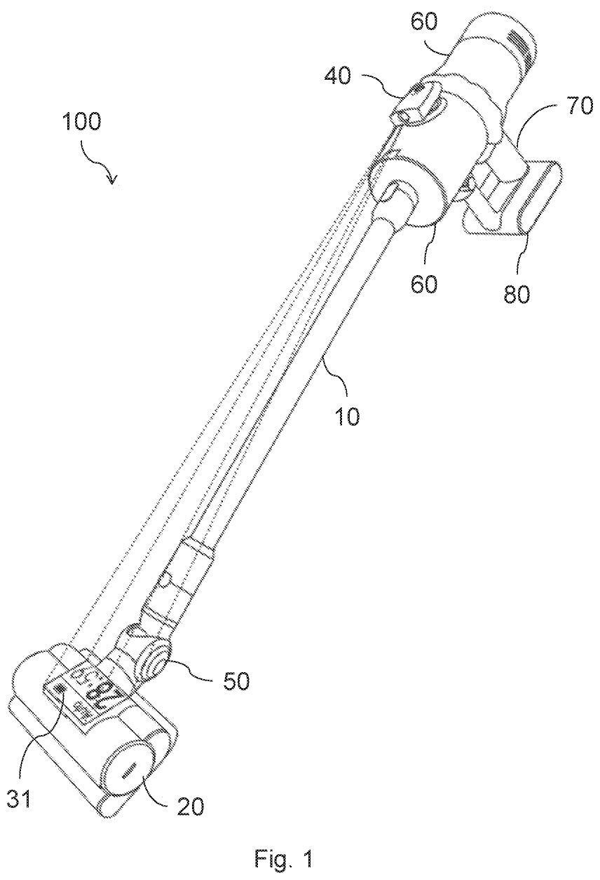

FIG. 1 schematically shows a vacuum cleaner 100 with a projection surface 31 on the cleaner head 20. The vacuum cleaner 100 comprises a main body 60 that comprises some of the core functional units of the vacuum cleaner 100, such as a motor for driving a suction fan and providing the suction power that is used for cleaning the floor surface. Of course, the use of the vacuum cleaner 100 is not limited to floors only. It can also clean other surfaces. The main body 60 may additionally comprise one or more filters for filtering dust and other dirt out of the suction air stream and a reservoir or bag for the collection of the filtered out dust and dirt. Alternative means for separating dirt particles from the suction air stream, such as, e.g., cyclonic particle separators can be used too. Power and control electronics may be provided for powering and controlling at least the motor. The motor and other electronic components may be battery powered, in which case the main body 60 may additional comprise a battery pack 80.

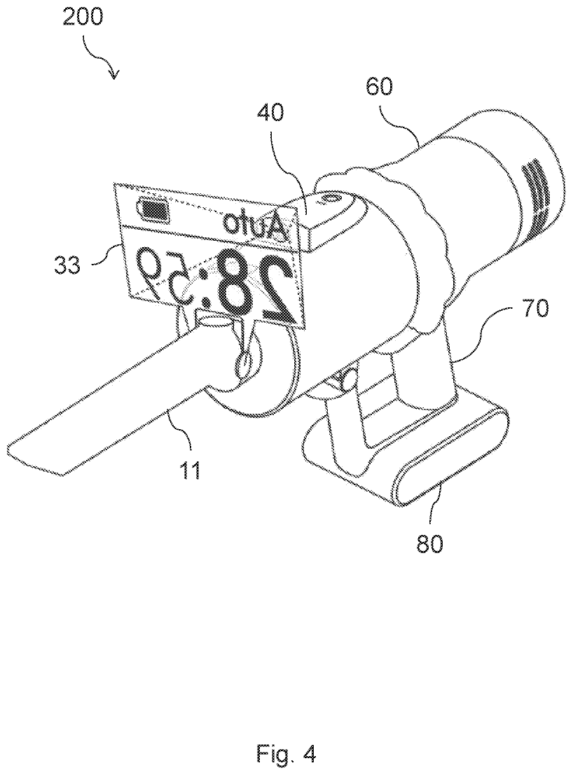

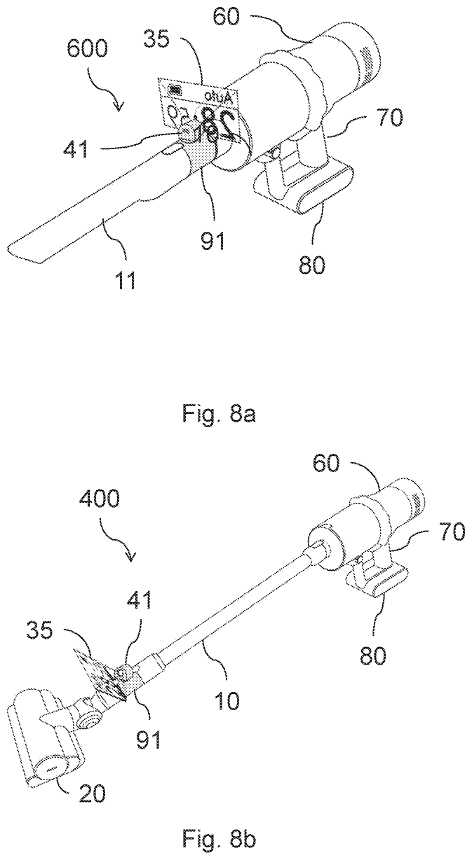

A grip or handle 70 is mounted to the main body to enable a user to grip and handle the vacuum cleaner during use. The main body 60 is mounted to a connector end of a wand 10. At the other end of the wand 10, a cleaner head 20 is provided that, during use, is moved over the surface to be cleaned, typically a floor surface. The cleaner head 20 shown in FIG. 1 extends in a direction, generally perpendicular to the longitudinal axis of the wand 10. Alternatively, the cleaner head may have a different shape, e.g. to enable reaching narrower, less accessible, places. A well-known example of a narrower cleaner head is a crevice tool. Crevice tools are typically the preferred type of cleaner heads used in handheld vacuum cleaners (see FIGS. 4 and 8a), but can also be used in stick type vacuum cleaners 100 as shown in FIG. 1. The cleaner head 20 is preferably mounted to the cleaner end of the wand 10 via a hinge 50 that allows for pivoting of the cleaner head 20 relative to the wand 10, such that the user has can choose to hold the cleaner head 20 closer to or further away from his own feet without the cleaner head 20 loosing contact with the floor surface. The joint 50 may be a simple hinge joint that only allows rotation of the wand 10 relative to the cleaner head 20 in a forward/backward direction. Preferably, the joint 50 is a ball joint that allows for moving the wand 10 in all directions.

In alternative embodiments of the invention (not shown), the main body 60 may be separate from the wand 10 and configured for riding over the floor surface. In that event, a hose may connect the main body 60 to the connector end of the wand 10. The user holds the wand 10 by the connector end and pulls the main body 60 through the room while using the wand 10 to move the cleaner head 20 over the floor surface.

A projector 40 is provided at the grip end of the wand 10. In this embodiment, the projector 40 is attached to an upper surface of the main body 60, but in other embodiments it may, e.g., be mounted to the wand 10 itself. The projector 40 is coupled to a controller that provides the images and/or data to be projected to the projector 40. The projector 40 emits a light beam in a direction generally parallel to the wand 10 and towards the projection surface 31 on top of the cleaner head 20. The projection surface 31 is preferably substantially flat and uniformly coloured to improve the legibility of the projected information. Preferably, the projector 40 is mounted on an electronically controllable swivel that can change the projection direction in dependence of the relative orientation of the projection surface 31.

It is to be noted that, throughout this description, the terms ‘projection’, ‘projected image’ and ‘projected information’ may be used interchangeably to refer to the image and information the user can see on the projection screen or projection surface 31. Such information may include text, images and other graphics and could include moving graphics as well as full-blown video or animation.

The cleaner head 20 is connected to the cleaner end of the wand 10 via a hinge 50. During use of the vacuum cleaner 100, the user moves the cleaner head 20 over the floor surface, while keeping its bottom surface generally parallel and in contact therewith. The hinge 50 allows the cleaner head 20 to pivot relative to the wand 10 and the user to vary his distance and orientation relative to the cleaner head 20. As a result of the pivotal movement, the angle of incidence of the projection onto the projection surface 31 changes, which may lead to displacement and deformation of the projection. Optionally, this deformation can be compensated for by adjusting the projection. For this purpose, an angle sensor may measure the current hinge angle and send it to the controller. Alternatively, a camera (not shown), e.g. provided adjacent the projector 40, may monitor the image that is projected on the projection surface 31. The controller can then use the camera image to determine when and how the projection has been displaced or deformed.

Based on the measured hinge angle or obtained camera image, the controller may then adapt the projection in order to compensate for the changed orientation of the projection surface 31. Adapting the projection may, e.g., be done by purposely deforming the image to be projected in such a way that it compensates for the deformation caused by the pivoting motion. Alternatively or additionally, the orientation of the projector 40 relative to the wand 10 may be adjusted mechanically or a lens or mirror in or near the projector 40 may be moved. Of course, different strategies for compensating for the changed orientation of the projection surface 31 may be combined.

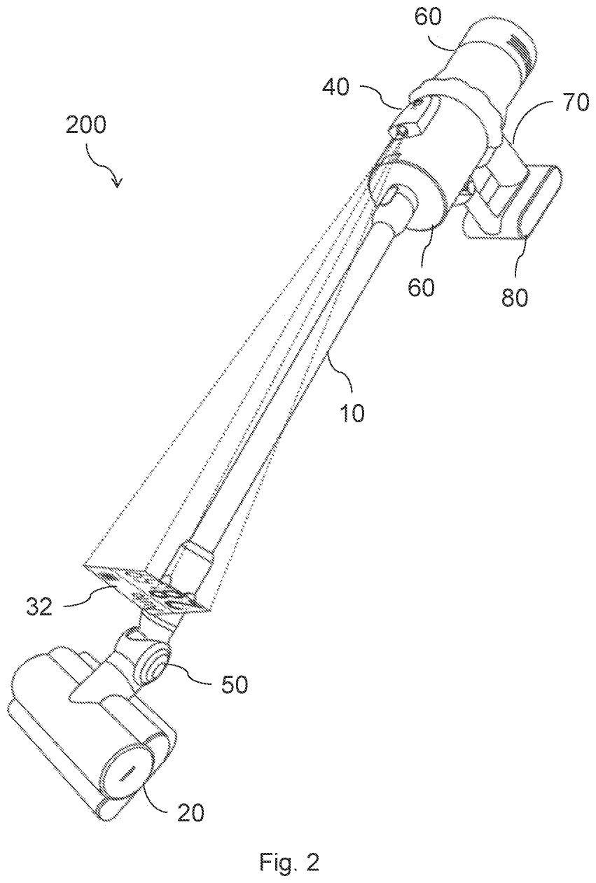

FIG. 2 schematically shows a vacuum cleaner 200 with a projection screen 32 mounted near the cleaner end of the wand 10. The projection screen 32 comprises the projection surface on which the projection is displayed. In this embodiment, the projection screen 32 is mounted to the wand 10, above the hinge 50 that moves relative to the wand 10. Alternatively, the projection screen 32 may be mounted to a non-moving upper portion of the hinge 50 that is fixedly attached to the wand 10. Although, compared to the embodiment of

FIG. 1, this embodiment needs extra parts (the screen 32, mounting elements) that may add to the total weight and cost of the vacuum cleaner 200, it obviates the need to adjust the projection when the cleaner head 20 pivots relative to the wand 10. The projection surface 32 is preferably uniformly coloured. White or other light colours are very suitable for providing sufficient contrast between the projected information and the background it is projected onto.

The projection surface 32 may be transparent or semi-transparent to allow the user to simultaneously read the projected information and keep an eye on the cleaner head 20 or the floor surface he is cleaning. The projection screen 32 may be provided as a flexible film, but it can also be more rigid. Even though it may be transparent, the projection screen 32 preferably has a size such that it does not completely obscure the view of the cleaner head 20. The projection may be such that it appears to be projected on the floor surface or cleaner head 20. A background colour and/or a colour of the projected information may be continuously or periodically adapted in dependence of the colour and texture of the floor surface in order to improve the readability of the information. Different profiles may be selectable for different floor types, floor colours or user preferences. Such profiles may be user selected or automatically activated in dependence of sensor input. A camera may be provided for that and other purposes, e.g. together with the projector 40 or in the cleaner head 20.

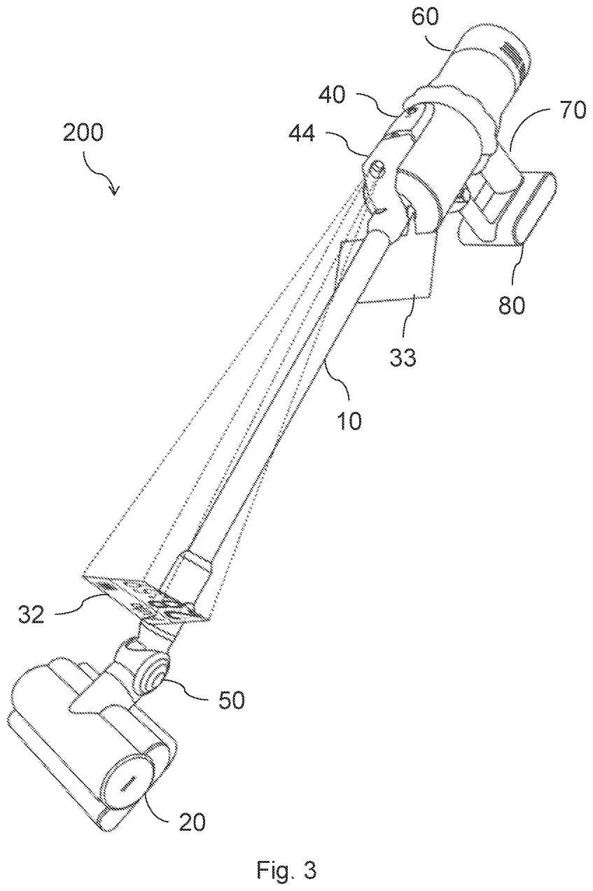

FIGS. 3 and 4 show a vacuum cleaner 200 with a projection system that can be used in different configurations. FIG. 3 shows the vacuum cleaner 200 in stick mode, i.e. with the wand 10 attached. In this mode, the vacuum cleaner 200 and the projection system function in the same way as the vacuum cleaner 100 of FIG. 2. However, in addition to the features already described above with reference to FIG. 2, this vacuum cleaner 200 now further comprises a projection screen 33 that is pivotably mounted and, optionally, a projection transformer 44 that are both mounted to the connector end of the wand 10.

When, as in FIG. 3, the vacuum cleaner 200 is in stick mode, the pivotable projection screen 33 is ‘hidden’ under the wand 10. The projection transformer 44 has a long throw lens and is positioned such that it receives the projection from the projector 40 and focuses the projection onto the projection screen 32 at the cleaner end of the wand 10. Alternatively, the projection may be focused onto the cleaner head 20, as in FIG. 1.

When the wand 10 is removed for handheld use of the vacuum cleaner 200, as shown in FIG. 4, also the projection transformer 44 is removed. In handheld mode, the wand 10 may, e.g., be replaced by a tool 11 or a cleaner head that is attached directly to the main body. In this handheld mode, the pivotable projection screen 33 is pivoted upward. This pivoting may be caused by, e.g. a biased spring (not shown) or by manual configuration by the user. The projector 40 now directly projects onto the pivotable screen 33, which is nicely provided in the line of view between the user and the surface he is cleaning. It is to be noted that similar functionality can be provided when replacing the pivotable projection screen 33 by a simple mountable second projection screen that is mounted to tool 11 or to the main body 60 of the vacuum cleaner 200 when in handheld mode only. This mountable second projection screen may be the original projection screen 32, but now mounted to either the cleaner end or the connector end of the tool 11,. In all embodiments, the projection film or screen may be removable and can be replaced if accidentally damaged.

The main function of the projection transformer 44 is to selectively provide a sharp projection on either the first projection screen 32 or on the pivotable projection screen 33, depending on the use of the vacuum cleaner 200 in stick mode or handheld mode. For this purpose, the vacuum cleaner 200 may, e.g., comprise a wand sensor (not shown) that is configured to detect the presence of the wand 10 and its connection to the main body 60. Such a sensor could, e.g., be a mechanical switch that is triggered by the mounting and dismounting of the wand 10 or by the pivoting of the pivotable projection screen 33. Alternatively, an electric contact sensor or an optical sensor is used for that purpose.

If no optical transformer 44 is used for focusing the projection during stick mode use, the transformer functionality may be embodied in the projector 40 itself. For example by mechanically manipulating lenses or mirrors comprised in the projector unit 40. Alternatively, the functionality of the projection transformer 44 may be partially or fully embodied in software that transforms the projection in such a way that the same projector 40 will project sharp images on either the cleaner end projector screen 32 when in stick mode or on the pivotable projection screen 33 during handheld mode use.

It is noted that, although the invention is typically beneficial for vacuum cleaners that can be used in both stick mode and handheld mode, it may also be used in handheld vacuum cleaners that cannot be used in stick mode. Also in a handheld vacuum cleaner, it can be beneficial to project information on a projection screen near the cleaner head; e.g. to project the information such that it can be read while looking at the surface being cleaned, or just because that appears to be a more practical location to install a reasonably sized display screen.

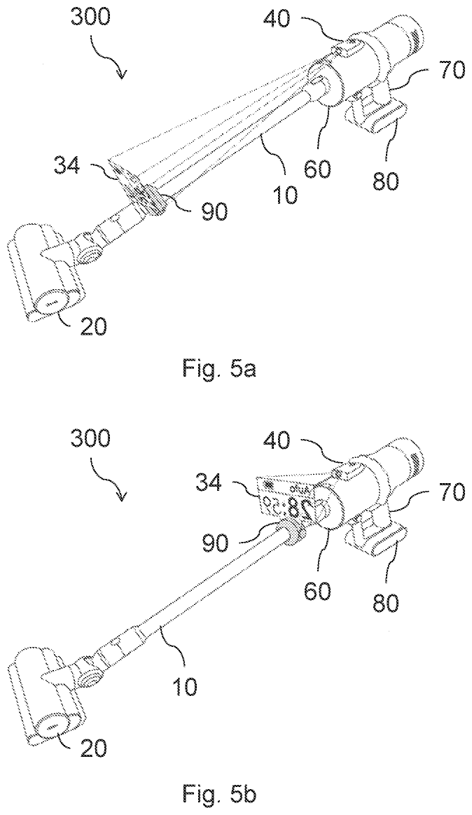

FIGS. 5a and 5b show a vacuum cleaner 300 with an adjustable projection screen 34. In FIG. 5a, the projection screen 34 is provided at the cleaner end of the wand 10. In FIG. 5b, the projection screen 34 is provided at the connector end of the wand 10. In this embodiment, the projection screen 34 is mounted to a slidable element 90 that, in use, can easily be slid over the wand 10 between the cleaner end and connector end positions. Preferably, when the wand 10 is removed for using the vacuum cleaner 300 in handheld mode, the slidable element 90 can be slid onto an end portion of the tool 10 close to the main body 60. Such an end portion may remain attached to said main body 60 when the remaining wand portion is removed. Alternatively, the slidable element 90 is made up of two parts that can be connected together for attaching the slidable element 90 to the wand or tool 10. The slidable element 90 makes it very easy to put the projection screen 34 in different positions for different uses. In addition to using the projection screen 34 at the cleaner end or the connector end of the wand, it may be possible to use it in one or more intermediate positions. Sensors may be provided for measuring the exact position of the slidable element 90 relative to the wand 10. Preferably, an auto-focus mechanism is provided for automatically adapting the projection to the position of the projection screen 34. Instead of a slidable element 90, a detachable element may be used and the wand 10 (or a different tool) may comprise one or more positions whereto the detachable element can be attached.

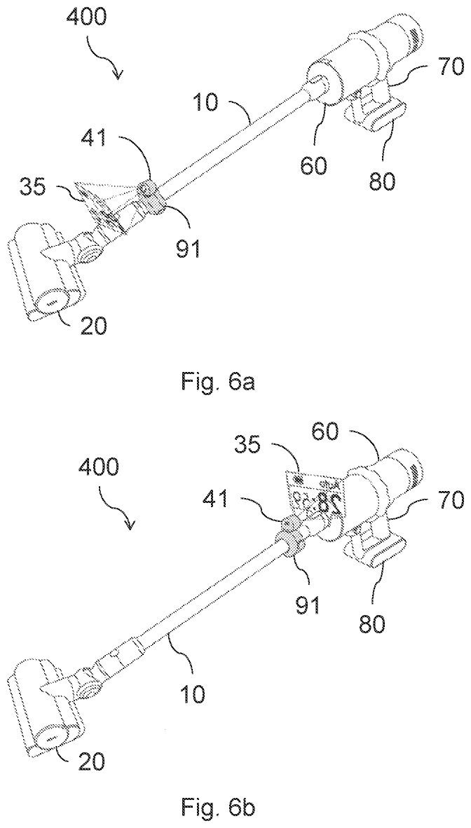

FIGS. 6a and 6b show a vacuum cleaner 400 with an adjustable projector 41. The adjustable projector 41 is provided on a slidable element 91, similar to the one described above with reference to FIGS. 5a and 5b. Because the projector 41 is not directly mounted to the main body 60, it is preferably configured for wireless communication with a control unit in that main body 60. In use, the main controller of the vacuum cleaner 400, or a dedicated projection controller communicating therewith sends the data or image to be projected to the adjustable projector 41 using this wireless communication. The adjustable projector 41 is rotatably mounted to the slidable element 91. When at the cleaner end of the wand 10 (FIG. 6a), the projector 41 is rotated such that it projects an image in the direction of the cleaner head 20, such that the projection is shown on a projection screen 35 mounted to the cleaner end of the wand 10, or to a cuff encircling the wand 10 and coupling the wand 10 to the cleaner head 20.

In this embodiment, the projection screen 35 can be taken from one end of the wand 10 and mounted to the other end, when the user desires to do so, for example when switching between stick mode and handheld mode. In FIG. 6b, the projection screen 35 is mounted to the connector end of the wand 10 or to a bin cuff encircling the wand 10. The slidable element 91 is slid towards the connector end too, e.g. to a part that remains attached to the main body 60 when working in handheld mode. The projector 41 is then rotated over 180° in order to be able to project onto the remounted projection screen 35. In this embodiment, the projection screen 35 is at least partially transparent in order to allow for projection from either side of the screen 35, while keeping the projection visible for the user. When projected from the rear, the projected image is mirrored in order to make it readable from the user's perspective.

In an alternative embodiment, the projection screen may be mounted to the slidable element 91 too. This makes it even easier to change the position of the projection screen. Because the projector 41 will move over the wand together with the screen, no adjustment of the projection is needed to compensate for the changing screen position. However, the data displayed may still depend on the projection screen position and/or cleaning mode. The projector 41 and the projection screen may together be rotatable with respect to the slidable element 91.

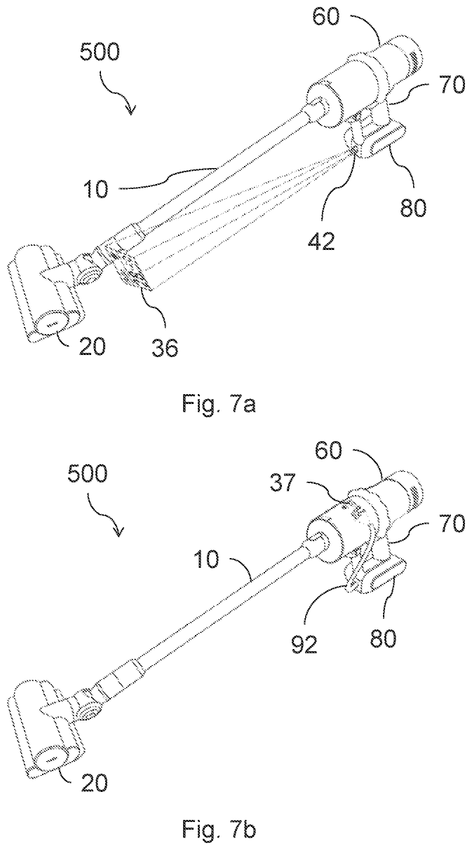

FIGS. 7a and 7b show a further example of a projection system that can be used in different configurations. In this vacuum cleaner 500, the projector 42 is embodied in the housing of the battery pack 80. It is noted that such positioning of the projector 42 may also be advantageous in other embodiments, e.g. in the embodiments of FIGS. 1-5. Mounting the projector 42 close to the battery pack 80 has the additional advantage that it simplifies the design of the power electronics for the projector 42 and can help in balancing the weight of the device 500. A projection screen 36 is now mounted to a side of the cleaner end of the wand 10 in order to prevent the wand 10 from obstructing the path for the projection from the projector 42 to the projection screen 36. The projection screen 36 may be mounted such as to keep at a constant angle relative to the projector 42.

Alternatively, the projection screen 36 is rotatable by the user around an axis perpendicular to the wand 10. If such rotation is made possible, the projection is preferably automatically adjusted to the current angle in order to provide the user with clearly readable information in all possible orientations of the projection screen 36. A sensor may be provided in the projection screen mount to detect the orientation of the projection screen. Alternatively, a camera may be provided at the main body 60 or may accompany the projector 42. Images captured by this camera are processed to derive the projection screen orientation therefrom.

In an even more advanced embodiment, an angle sensor for monitoring the current hinge angle, as described above with reference to FIG. 1, may be provided to obtain information about the position and orientation of the projection screen 36 relative to the floor surface.

This information may then be used to adapt the projection accordingly, e.g. by adjusting the orientation of the projection screen 36 relative to the wand and/or by adjusting the projection sent out by the projector 42.

FIG. 7b shows an alternative way of using the projector 42 of this vacuum cleaner 500, not requiring the presence of the mounted projection screen 36. This could be useful in stick mode, as shown in this figure, as well as in handheld mode. An optical fibre 92 is connected to the output of the projector 42. The connection between the projector 42 and the optical fibre 92 can be made in a conventional way using a push or screw fitting. The other end of the optical fibre 92 leads to a projection surface 37 on top of the main body 60. There the other end may be held in place by a simple mechanical connector, allowing the optical fibre 92 to project the projected information onto the projection surface 37. The end of the optical fibre 92 may comprise a lens that ensures that a properly focused projection is shown on the projection surface. Alternatively, the optical fibre 92 may be connected to a projection hub (not shown) that does the same.

The projector 42 may include a sensor that detects when the optical fibre 92 is connected and the projected information may be changed or adjusted in response thereto. Further, because the projection surface 37 on the main body will probably have a different colour and texture than the projection screen 36 shown in FIG. 7a (which may be partly transparent), also background colours, font size and other graphical aspects of the projected image may be adapted to increase legibility and ease of use.

FIGS. 8a and 8b show an example of a projection system that can be used with different types of vacuum cleaners 400, 600. The projection system shown here uses a slidable element 91 to which a projector 41 and a screen 35 are mounted. Separate front and rear mounting positions for the screen 35 may be arranged on the slidable element 91 for enabling both front and rear projection similar to what is shown in FIGS. 6a and 6b. Alternatively, the slidable element 91 can be detached from the tool 11 or wand 10 and turned over 180° before it is reattached, in order to enable both front and rear projection without requiring a second mounting position for the screen 35 or a pivot for rotating the projector 41.

In other embodiments, separate slidable elements may be used for carrying the projector 41 and the screen 35 and the separate slidable elements can be attached in different order and/or at different orientations to enable to provide useful projections for different vacuum cleaners and/or for vacuum cleaners that are used in different modes.

Instead of slidable elements, otherwise detachable or displaceable elements may be used. The wand 10 or tool 11 will then comprise one or more positions that are suitable for the attachment of the detachable element. In a further example, the projector surface and/or the projector may be provided on special connector pieces that can be inserted in between the main body 60 and the wand 10 or tool 11 and/or in between the wand 10 or tool 11 and a cleaner head 20 that is to be attached thereto.

It will be appreciated that the description above describes a large number of different embodiments with different features and combination of features. Where such features are described in relation to one or a few possible embodiments only, it should be clear that, if technically possible, these features can also be used in the other embodiments. The specific exemplary embodiments are therefore not to be understood to limit the scope of the invention in any way. As always, the scope of the invention is defined by the appended claims.

1. A vacuum cleaner for cleaning a surface, the vacuum cleaner comprising:
a main body,
a tool with a connector end for connection to the main and a cleaner end opposite the connector end,
a projection surface, provided on the tool, for displaying projected information thereon, and
a projector for casting a projection comprising the projected information onto the projection surface.

2. The vacuum cleaner as claimed in claim 1, wherein the tool comprises a cleaner head provided at its cleaner end.

3. The vacuum cleaner as claimed in claim 2, wherein the projection surface is provided on a top surface of the cleaner head.

4. The vacuum cleaner as claimed in claim 1, wherein the projection surface is configured for being detachably mounted to
at least two different locations on the tool, or
at least one location on the tool and at least one location on the main body.

5. The vacuum cleaner as claimed in claim 1, further comprising a second projection surface, provided on the main body.

6. The vacuum cleaner as claimed in claim 2, wherein the tool comprises a wand.

7. The vacuum cleaner as claimed in claim 6, wherein the projection surface is mounted to the wand.

8. The vacuum cleaner as claimed in claim 6, wherein the cleaner head is connected to the wand by a hinge and wherein the projection surface is mounted to a portion of the hinge that is fixedly mounted to the wand.

9. The vacuum cleaner as claimed in claim 6, wherein the cleaner head is connected to the wand by a hinge, and wherein the projector is configured for adjusting the projection in dependence of an angular position of the hinge.

10. The vacuum cleaner as claimed in claim 6, configured for being used in a stick mode with the wand attached to the main body and in a handheld mode with the wand removed from the main body.

11. The vacuum cleaner as claimed in claim 10, wherein the projector is configured for adjusting the projection in dependence of a switch between the handheld mode and the stick mode.

12. The vacuum cleaner as claimed in claim 10, wherein the projector is arranged to be coupled to an optical fibre in such a way that, in the handheld mode, the projection is cast onto the projection surface via the optical fibre.

13. The vacuum cleaner as claimed in claim 6, wherein the projection surface is mounted to the wand via a slidable mount that is freely movable between a cleaner end and a connector end of the wand.

14. The vacuum cleaner as claimed in claim 13, wherein the projector is configured for adjusting the projection in dependence of a position of the slidable mount relative to the wand.

15. A vacuum cleaner for cleaning a floor surface, the vacuum cleaner comprising:
a wand with a connector end and a cleaner end,
a cleaner head provided at the cleaner end of the wand,
a projection surface for displaying projected information thereon and being configurable to be selectively provided at the cleaner end of the wand or at the connector end of the wand,
a slidable mount that is freely movable between the cleaner end and the connector end of the wand, and
a projector, mounted to the slidable mount, for casting a projection comprising the projected information onto the projection surface.

16. The vacuum cleaner as claimed in claim 15, wherein the projection surface is mounted to the slidable mount.

17. The vacuum cleaner as claimed in claim 15, wherein the projector is adaptably mounted to the slidable mount such that the projection can be selectively casted in either the direction of the cleaner end or in the direction of the connector end of the wand.

18. The vacuum cleaner as claimed in claim 1, wherein the projection surface is made of an at least partially transparent material.

19. The vacuum cleaner as claimed in claim 18, wherein the projector is configured for adjusting a background colour of the projection and/or a colour of the projected information in dependence of a colour and/or texture of the surface.

20. A detachable element configured for attachment to a tool of a vacuum cleaner for cleaning a surface, the detachable element comprising:
a projection surface for displaying projected information thereon, and
a projector for casting a projection comprising the projected information onto the projection surface.

21. The detachable element as claimed in claim 20, wherein the tool comprises a wand and wherein the detachable element is a slidable mount that is configured to be freely movable over at least a portion of the wand.

22. The detachable element as claimed in claim 20, wherein the detachable element comprises a first detachable element part and a separate or separable second detachable element part, the first detachable element part comprising the projection surface and the second detachable element part comprising the projector.
